(19) United States
(12) Patent Application Publication
(10) Pub. No.: US 2005/0198088 A1
(43) Pub. Date: Sep. 8, 2005

(54) Method and system for improving the concurrency and parallelism of mark-sweep-compact garbage collection

(76) Inventors: Sreenivas Subramoney, Palo Alto, CA (US); Richard L. Hudson, Florence, MA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/793,707

(22) Filed: Mar. 3, 2004

(51) Int. Cl. G06F 17/30

(52) U.S. Cl. 707/206

(57) ABSTRACT

An arrangement is provided for using only one bit vector per heap block to improve the concurrency and parallelism of mark-sweep-compact garbage collection in a managed runtime system. A heap may be divided into a number of heap blocks. Each heap block has only one bit vector used for marking, compacting, and sweeping, and in that bit vector only one bit is needed per word or double word in that heap block. Both marking and sweeping phases may proceed concurrently with the execution of applications. Because all information needed for marking, compacting, and sweeping is contained in a bit vector for a heap block, multiple heap blocks may be marked, compacted, or swept in parallel through multiple garbage collection threads. Only a portion of heap blocks may be selected for compaction during each garbage collection to make the compaction incremental to reduce the disruptiveness of compaction to running applications and to achieve a fine load-balance of garbage collection process.

### BACKGROUND

1. Field

The present invention relates generally to managed runtime environments and, more specifically, to methods and apparatuses for improving the concurrency and parallelism of mark-sweep-compact garbage collection.

2. Description

The function of garbage collection, i.e., automatic reclamation of computer storage, is to find data objects that are no longer in use and make their space available for reuse by running programs. Garbage collection is important to avoid unnecessary complications and subtle interactions created by explicit storage allocation, to reduce the complexity of program debugging, and thus to promote fully modular programming and increase software application maintainability and portability. Because of its importance, garbage collection has become an integral part of managed runtime environments.

The basic functioning of a garbage collector may comprise three phases. In the first phase, all direct references to objects from currently running threads may be identified. These references are called roots, or together a root set, and a process of identifying all of such references may be called root set enumeration. In the second phase, all objects reachable from the root set may be searched since these objects may be used in the future. An object that is reachable from any reference in the root set is considered a live object (a reference in the root set is a reference to a live object); otherwise it is considered a garbage object. An object reachable from a live object is also live. The process of finding all live objects reachable from the root set may be referred to as live object tracing (or marking and scanning). In the third phase, storage space of garbage objects may be reclaimed (garbage reclamation). This phase may be conducted either by a garbage collector or a running application (usually called a mutator). In practice, these three phases, especially the last two phases, may be functionally or temporally interleaved and a reclamation technique may be strongly dependent on a live object tracing technique.

One garbage collection technique is called mark-sweep-compact collection. Mark-sweep-compact garbage collection comprises three phases: live object tracing, live object compacting, and storage space sweeping. In the live object tracing phase, live objects are distinguished from garbage by tracing, that is, starting at the root set and actually traversing the graph of pointer/object relationships. In mark-sweep-compact garbage collection, the objects that are reached from the root set are marked in some way, either by altering bits within the objects, or perhaps by recording them in a bitmap or some other kind of table. Once the live objects are marked, i.e., have been made distinguishable from the garbage objects, at least a portion of the live objects are compacted. Live object compaction may help solve the storage space fragmentation problem. In an ideal situation, most of live objects are moved in the live object compacting phase until all of the live objects are contiguous so that the rest of storage space is a single contiguous free space. In practice, making all the live objects residing in a contiguous space at one end of the entire storage space during each garbage collection cycle may take so long a time that garbage collection becomes too disruptive to running mutators. Therefore, in some cases, the entire storage space is divided into small storage blocks. During a garbage collection cycle, live objects in only a portion of all small storage blocks are compacted, leaving live objects in the rest of the small storage blocks as they are. In a subsequent garbage collection cycle, another portion of all small storage blocks may be selected for live object compaction. Such an incremental compaction approach may help solve the storage space fragmentation problem without causing undue disruption to mutators. After the compacting phase, the entire storage space may be swept, that is, exhaustively examined, to find all of the unmarked objects (garbage) and reclaim their space. The reclaimed objects are usually linked onto one or more free lists so that they are accessible to the allocation routines. The storage space sweeping may be referred to as a sweeping phase. The sweeping phase may be conducted by a garbage collector or a mutator.

Typically, all mutators must stop running during the live object compacting phase to avoid any errors that may be caused by live object relocation (a garbage collector that stops execution of all mutators is also called “stop-the-world” garbage collector). A garbage collection technique that stops the execution of mutators may be called a blocking garbage collection technique; otherwise, it may be called a non-blocking garbage collection technique. Obviously it is desirable to use a non-blocking garbage collection to decrease the disruptiveness of garbage collection in a managed runtime environment. Although it may be difficult to make the live object compacting phase concurrent with execution of mutators, it is still desirable to reduce the time required by this phase. To improve the overall performance of a managed runtime environment, it is desirable to improve the concurrency between the live object tracing phase and the storage space sweeping phase and the concurrency between these two phases and execution of mutators. Additionally, it is desirable to increase the parallelism during the live object tracing phase between different garbage collection threads.

### BRIEF DESCRIPTION OF THE DRAWINGS

The features and advantages of the present invention will become apparent from the following detailed description of the present invention in which:

FIG. 1 depicts a high-level framework of an example managed runtime system that uses one efficient bit vector to improve the concurrency and parallelism of mark-sweep-compact garbage collection, according to an embodiment of the present invention;

FIG. 2 is an exemplary flow diagram of a high-level process in which mark-sweep-compact garbage collection using one efficient bit vector is performed in a managed runtime system, according to an embodiment of the present invention;

FIG. 3 is a high-level functional block diagram of components that are desired to improve the concurrency and parallelism of mark-sweep-compact garbage collection, according to an embodiment of the present invention;

FIG. 4 is a schematic illustration of the structure of a heap block where a bit vector as well as objects are stored, according to an embodiment of the present invention;

FIG. 5 is a schematic illustration of the correspondence between objects and mark bits in a heap block, according to an embodiment of the present invention;

FIG. 6 is an exemplary functional block diagram of a concurrent parallel tracing mechanism that performs concurrent parallel marking functionality during mark-sweep-compact garbage collection, according to an embodiment of the present invention;

FIG. 7 is an exemplary flow diagram of a process of concurrent marking in using a tri-color approach, according to one embodiment of the present invention;

FIG. 8 is a schematic illustration of parallel marking in a heap block, according to an embodiment of the present invention;

FIG. 9 is an exemplary functional block diagram of a parallel incremental compacting mechanism that performs parallel incremental sliding compaction during mark-sweep-compact garbage collection, according to an embodiment of the present invention;

FIG. 10(a)-(c) are schematic illustrations of phases involved in parallel incremental sliding compaction during mark-sweep-compact garbage collection, according to an embodiment of the present invention;

FIG. 11 is an exemplary flow diagram of a process in which parallel incremental sliding compaction is performed during mark-sweep-compact garbage collection, according to an embodiment of the present invention;

FIG. 12 is an exemplary flow diagram of a high-level process in which the concurrency and parallelism of mark-sweep-compact garbage collection is improved, according to an embodiment of the present invention; and

FIG. 13 is a schematic illustration of how concurrency is achieved among garbage collection threads and between garbage collection threads and mutator threads during mark-sweep-compact garbage collection, according to an embodiment of the present invention.

### DETAILED DESCRIPTION

An embodiment of the present invention is a method and apparatus for improving the concurrency and parallelism of mark-sweep-compact garbage collection by using an efficient bit vector. The present invention may be used to increase the opportunity for conducting live object tracing and storage space sweeping phase concurrently with the execution of mutators. The present invention may also be used to improve the parallelism during the live object tracing phase and the live object compacting phase among multiple garbage collection threads in a single or a multi-processor system. Using the present invention, a storage space may be divided into multiple smaller managed heap blocks. A heap block may have a header area and a storage area. The storage area may store objects used by running mutators, while the header area may store information related to this block and objects stored in this block. The header area may contain at least one bit vector to be used for marking and compacting live objects and sweeping the heap block. Two consecutive bits in a bit vector may be used to mark and compact a live object, respectively. This arrangement may allow only one bit vector to be used for both marking and compacting and thus result in less space overhead incurred by mark-sweep-compact garbage collection. Storage space sweeping may also share the bit vector with marking and compacting so that more space overhead may be reduced. By dividing storage space into smaller heap blocks with each heap block having its own bit vector for marking, compacting, and sweeping, multiple garbage collection threads may perform marking and compacting in parallel, and at the same time, mutators may be allowed to run concurrently during marking and sweeping phases.

Reference in the specification to “one embodiment” or “an embodiment” of the present invention means that a particular feature, structure or characteristic described in connection with the embodiment is included in at least one embodiment of the present invention. Thus, the appearances of the phrase “in one embodiment” appearing in various places throughout the specification are not necessarily all referring to the same embodiment.

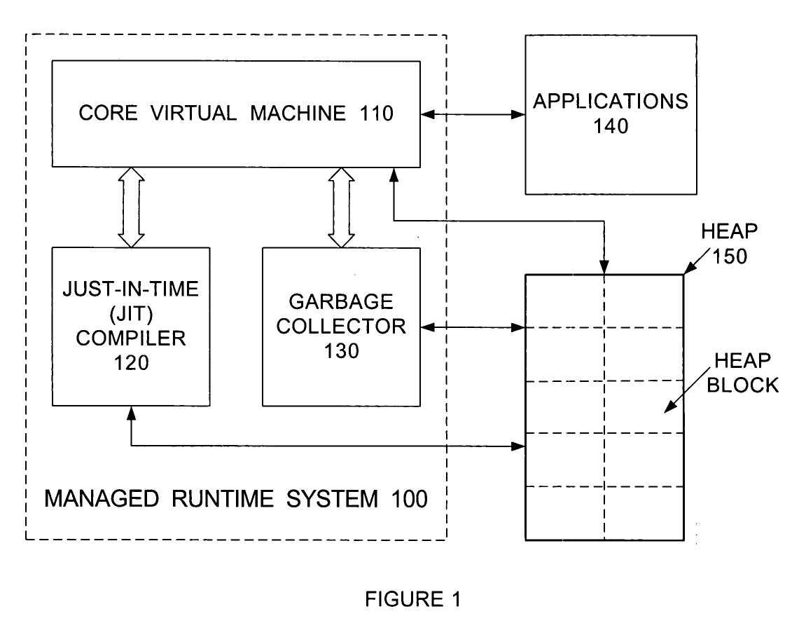

FIG. 1 depicts a high-level framework of an example managed runtime system that uses one efficient bit vector to improve the concurrency and parallelism of mark-sweep-compact garbage collection, according to an embodiment of the present invention. The managed runtime system 100 may comprise a core virtual machine (VM) 110, at least one Just-In-Time (JIT) compiler 120, and a garbage collector 130. The core VM 110 is an abstract computing machine implemented in software on top of a hardware platform and operating system. The use of a VM makes software programs independent from different hardware and operating systems. A VM may be called a Java Virtual Machine (JVM) for Java programs, and may be referred to as other names such as, for example, Common Language Infrastructure (CLI) for C# programs. In order to use a VM, a program must first be compiled into an architecture-neutral distribution format, i.e., intermediate language such as, for example, bytecode for a Java program. The VM interprets the intermediate language and executes the code on a specific computing platform. However, the interpretation by the VM typically imposes an unacceptable performance penalty to the execution of an intermediate language code because of large runtime overhead processing. A JIT compiler has been designed to improve the VM's performance. The JIT compiler 120 compiles the intermediate language of a given method into a native code of the underlying machine before the method is first called. The native code of the method is stored in memory and any later calls to the method will be handled by this faster native code, instead of by the VM's interpretation.

The core virtual machine 110 may set applications 140 (or mutators) running and keep checking the level of free space in a storage space while the applications are running. The storage space may also be referred to as a heap 150, which may further comprise multiple smaller heap blocks as shown in FIG. 1. The mutators may be executed in multiple threads. Once free storage space in the heap falls below a threshold, the core virtual machine may invoke garbage collection, which may run in multiple threads and concurrently with execution of the mutators. First, all direct references (a root set) to objects from the currently executing programs may be found through root set enumeration. Root set enumeration may be performed by the core virtual machine 110 or the garbage collector 130. After a root set is obtained, the garbage collector may trace all live objects reachable from the root set across the heap. Live objects in the heap may be marked in a bit vector in a marking phase during live object tracing process. The bit vector may also be referred to as a mark bit vector. In one embodiment, a heap block may have its own mark bit vector for marking live objects in the heap block. This may help keep the size of the mark bit vector small so that it may be easier to load the mark bit vector into cache when necessary. In another embodiment, there may be only one mark bit vector for an entire heap for marking all live objects in the heap. Yet in another embodiment, there may be more than one mark bit vector for all heap blocks stored in a designated area in a heap. If there are multiple garbage collection threads, these threads may be made to be able to mark a mark bit vector in parallel.

Based on the information contained in a mark bit vector, a heap block of the heap may be compacted so that only live objects reside contiguously at one end of the heap block (normally close to the base of the heap block) leaving a contiguous allocable space at the other end of the heap block (normally close to the end of the heap block). A compacting phase may scan the mark bit vector to find live objects and set their corresponding forwarding bits in a forwarding bit vector when their new destination addresses are installed. In one embodiment, the forwarding bit vector may be a separate bit vector from the mark bit vector for a heap block. In another embodiment, the forwarding bit vector may share a same bit vector with the mark bit vector for a heap block to save storage space and time. Based on the information in the forwarding bit vector, slots that originally point to a live object may be repointed to the new destination address and the live object may be copied to a new location in the heap block corresponding to its new destination address. Since the compacting phase involves moving of live objects, all mutator threads are normally suspended before the compacting phase starts and resumed after the compacting phase completes, to avoid possible errors due to object moving. In one embodiment, only a fraction of heap blocks in the heap may be chosen for compaction at each garbage collection cycle to reduce the interrupting effect of the compacting phase. In another embodiment, all heap blocks in the heap may be compacted at certain garbage collection cycles or at each garbage collection cycle. After a heap block is compacted, the heap block is also swept, that is, the contiguous storage space not occupied by compacted live objects is ready for new space allocation by mutator threads.

For a heap block that has not been compacted, a sweeping phase may search all unmarked objects (garbage) according to mark bits in the mark bit vector of the heap block and make their space accessible to allocation routines. The sweeping phase may be conducted by a mutator. In one embodiment, the sweeping phase may share the same bit vector with the marking phase. With this arrangement, the marking phase and the sweeping phase may proceed sequentially. In another embodiment, a different bit vector (sweep bit vector) may be used for the sweeping phase. At the end of the marking phase, the mark bit vector and the sweep bit vector may be toggled, i.e., the mark bit vector may be used by the sweeping phase as a sweep bit vector and the sweep bit vector may be used by the live object tracing phase as a mark bit vector. By toggling the mark bit vector and the sweep bit vector, the sweeping phase may proceed concurrently with the marking phase, but using a mark bit vector set during the immediately preceding marking phase.

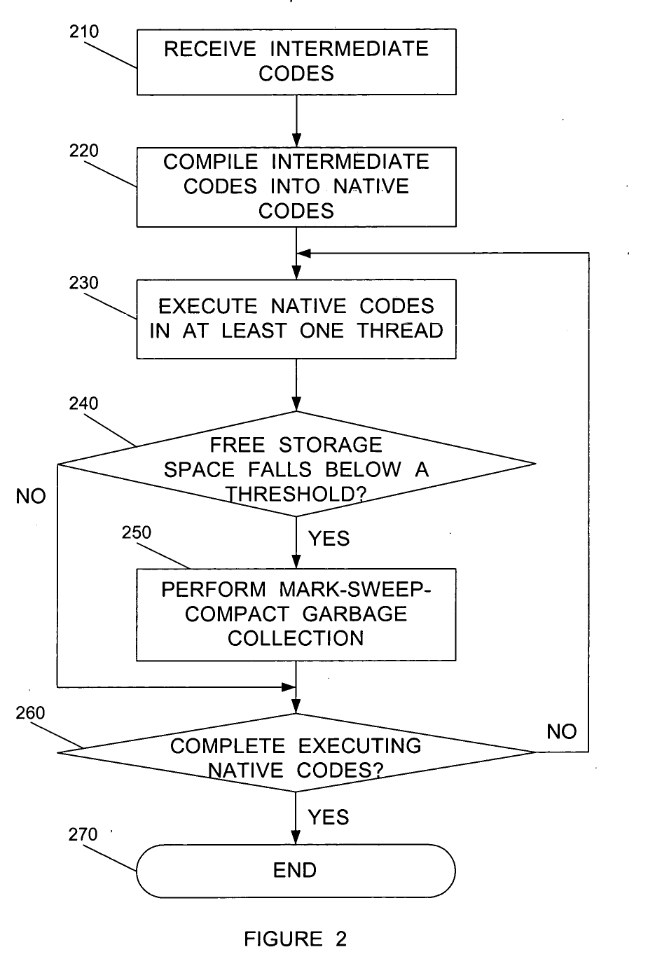

FIG. 2 is an exemplary flow diagram of a high-level process in which mark-sweep-compact garbage collection using one efficient bit vector is performed in a managed runtime system, according to an embodiment of the present invention. At block 210, intermediate codes may be received by the VM. At block 220, the intermediate codes may be compiled into native codes by a JIT compiler. At block 230, the native codes may be set by the VM to run in one or more threads by one or more processors. At block 240, free storage space in a heap may be checked. If the free storage space in the heap falls below a threshold, mark-sweep-compact garbage collection using only one bit vector for both marking and compacting may be invoked and performed at block 250; otherwise, the execution progress of the native codes may be checked at block 260. If the native code execution is complete, the process for running the native codes may end at block 270; otherwise, the VM may continue executing the native codes by reiterating processing blocks from block 230 to block 250.

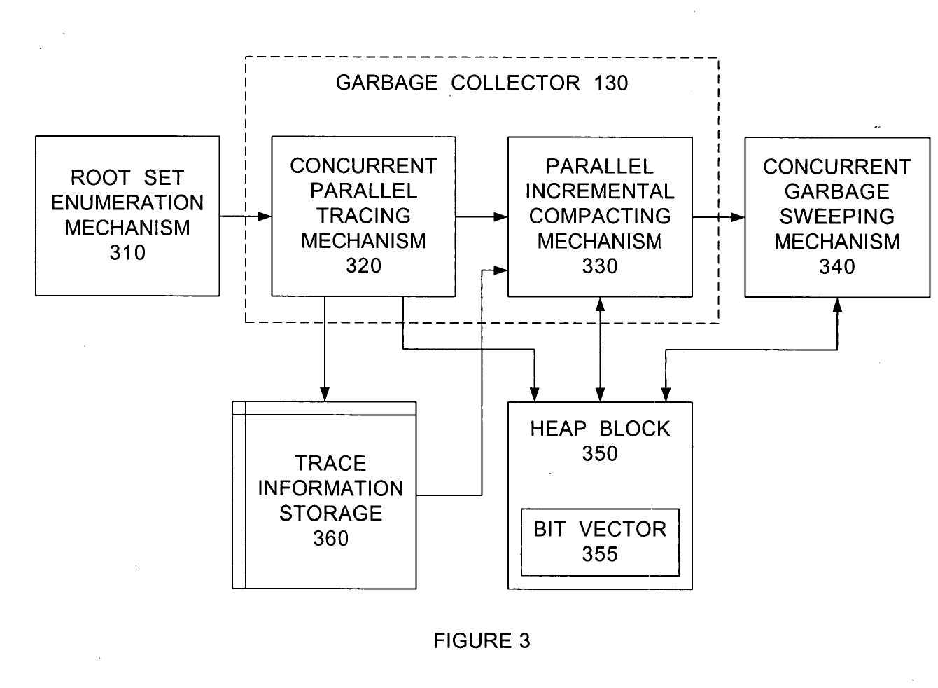

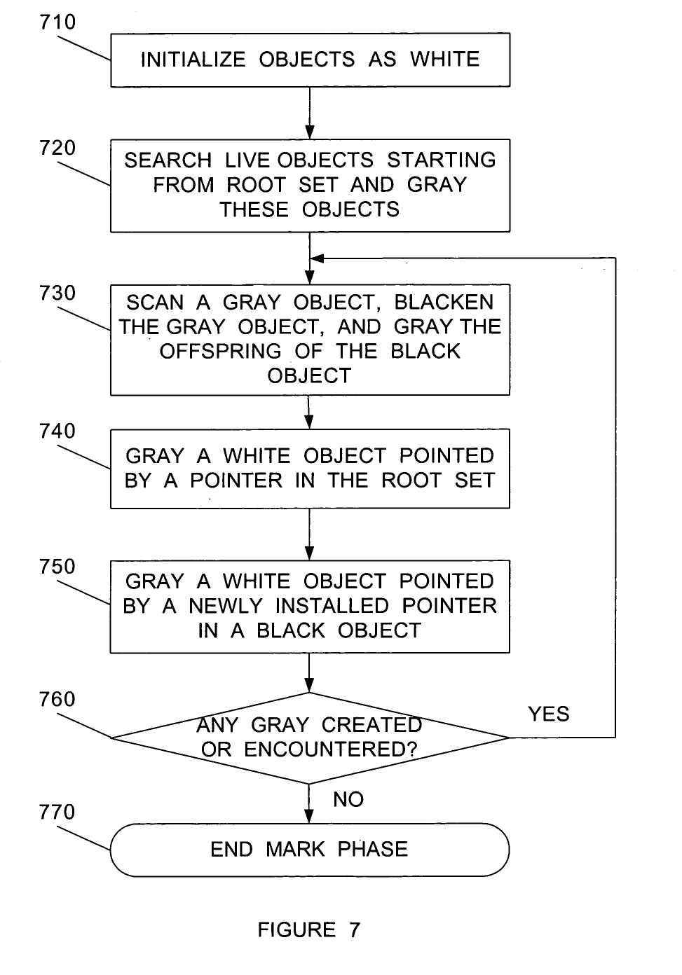

FIG. 3 is a high-level functional block diagram of components that are desired to improve the concurrency and parallelism of mark-sweep-compact garbage collection, according to an embodiment of the present invention. Root set enumeration mechanism 310 may identify live references based on currently executing mutator threads. These live references together form a root set, from which all live objects may be traced. In one embodiment, the root set enumeration mechanism 310 may be part of the VM 110. In another embodiment, the root set enumeration mechanism 310 may be part of the garbage collector 130. For concurrent garbage collection, the root set might not include all live references at the time the root set is formed mainly because concurrently running mutators may create new live references while the root set enumeration mechanism is identifying live references. One way to prevent a garbage collector from reclaiming space occupied by live objects traceable from any newly created live reference during the root set enumeration process is to perform tri-color tracing, which will be described in FIG. 7.

The garbage collector 130 may comprise at least one concurrent parallel tracing mechanism 320 and at least one parallel incremental compacting mechanism 330. The concurrent parallel tracing mechanism 320 may mark and scan live objects in each heap block of a heap by traversing a graph of reachable data structures from the root set (hereinafter “reachability graph”). For a heap block 350, the concurrent parallel tracing mechanism may set those bits corresponding to live objects in the heap block in a bit vector 355. Once all live objects in the heap block 350 are properly marked in the bit vector 355, that is, all live objects in the heap block are marked and scanned and their corresponding mark bits in the bit vector are set, the heap block is ready for compaction. The reachability graph may change because concurrently running mutator threads may mutate the reachability graph while the concurrent parallel tracing mechanism is tracing live objects. A tri-color tracing approach, which will be described in FIG. 7, may be used to coordinate with the concurrent parallel tracing mechanism to ensure that no live objects are erroneously treated as garbage objects.

During the marking phase, reference slots of a live object are also checked. The reference slots may store addresses that the live object points to. The addresses may correspond to live objects in other heap blocks, which may be compacted in the compacting phase. The information about a reference slot of the live object may be recorded in a trace information storage 360. The trace information storage 360 may reside in or associate with the heap block that the live object points to.

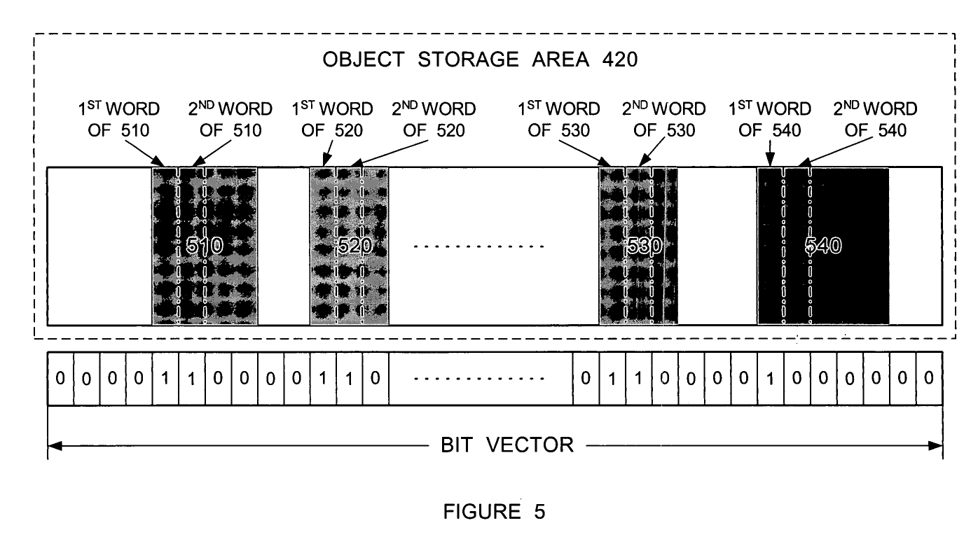

The parallel incremental compacting mechanism 330 may select a portion of heap blocks in a heap for compaction. For the heap block 350, the parallel incremental compacting mechanism may examine the bit vector 355 to find live objects because only mark bits of live objects are set during the marking phase. The parallel incremental compacting mechanism may then determine a new destination address for each live object; install the new address in the head of that live object; and set the forwarding bit for that live object in the bit vector. Marking bits and forwarding bits may be stored in the same bit vector. FIG. 5 shows the structure of the bit vector for a heap block in more detail. Based on those set forwarding bits in the bit vector 355 and the information in the trace information storage 360, the parallel incremental compacting mechanism may repoint references in those live objects, which originally point to a live object in the heap block 350, to the new destination address of the live object and slide the live object to the new location in the heap block corresponding to the object's new destination address. After compacting, all live objects reside in a contiguous space at one end of the heap block leaving a contiguous allocable space at the other end of the heap block.

When a mutator thread runs out of storage space, it may grab a new heap block from the garbage collector. If the heap block has been swept previously, that is, it was compacted in the immediately preceding garbage collection cycle, the mutator thread may begin directly allocating objects from the heap block. If not, the mutator thread needs to activate a concurrent garbage sweeping mechanism 340 to sweep the heap block. The concurrent garbage sweeping mechanism may use a sweep bit vector which is separate from the bit vector for mark bits and forwarding bits. The sweep bit vector may toggle with the mark bit vector at the end of the compacting phase so that the sweeping phase of the current garbage collection cycle may proceed concurrently with the marking phase of the next garbage collection cycle. In one embodiment, the garbage sweeping mechanism 350 may be a part of the garbage collector 130. In another embodiment, the garbage sweeping mechanism 350 may be a part of a mutator.

The garbage sweeping mechanism may prepare storage space occupied by all garbage objects (objects other than live objects) and make the storage space ready for allocation by currently running mutators. The garbage sweeping mechanism may only sweep a region occupied by garbage objects if the region is larger than a threshold (e.g., 2 k bytes) since a smaller space might not be very useful. The size of a region occupied by garbage objects may be determined from the sweep bit vector, that is, the number of bits between two set bits, which are separated by contiguous zeros, minus the number of bytes of the live object represented by the first set bit may be a very close approximate of the number of bytes occupied by dead objects. Thus, all allocation areas in a heap block may be determined with just one linear pass of the bit vector in the header of the heap block. The sweeping approach based on the information in the bit vector can, therefore, have good cache behavior because only one bit vector need be loaded into the cache. While one mutator thread is sweeping a heap block through a concurrent garbage sweeping mechanism, the other mutator threads may continue executing their programs to increase the concurrency of the sweeping process. When each heap block has its own bit vector to record mark bit information, multiple mutator threads may activate one or more multiple concurrent garbage sweeping mechanisms to sweep multiple heap blocks at the same time to increase the parallelism of the sweeping process.

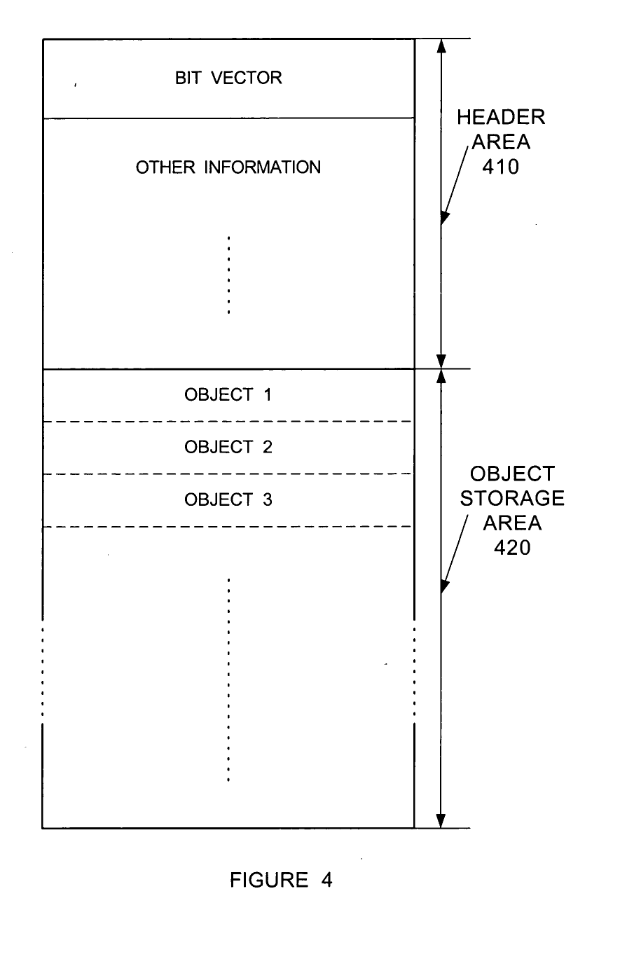

FIG. 4 is a schematic illustration of the structure of a heap block where a bit vector as well as objects are stored, according to an embodiment of the present invention. A heap block may comprise two areas: a header area 410 and an object area 420. The object storage area 420 may store objects used by mutators. The header area 410 may include a bit vector. When garbage collection is invoked for the first time, the bit vector may be initialized. For instance, each bit in the bit vector may be set to zero after the initialization. The number of bits in the bit vector may represent the number of total words in the object storage area 420. One word consists of 4 bytes on a 32-bit machine. Normally objects are word aligned, that is, an object in the object storage space 420 can only start at the beginning of a word. Therefore, bits in the bit vector can record every possible start of an object in the object storage area. For garbage collection purpose, only live objects in the object storage area are needed to be marked in the bit vector. For example, by setting a bit corresponding to the starting word of a live object to 1, the location of the live object in the object storage may be identified. Usually the first few words in an object are used to store general information about the object such as, for example, the size of the object, and a forwarding pointer (i.e., destination address) for the compacting purpose. These first few words may be considered as a header of the object. By combining the starting word of the object contained in the mark bit vector and the size information contained in object header, the storage space occupied by this object may be identified. The correspondence between objects and bits in the bit vector may be illustrated in FIG. 5, according to an embodiment of the present invention. The object storage area 420 may comprise several live objects, for example, 510, 520, 530, and 540. Since the mark bit vector has one bit corresponding to each word of the object storage area 420, the starting word of a live object may be marked by setting the corresponding bit to a value (e.g., 1) different from a default value (e.g., 0). The default value is a value set for all bits in the bit vector during the initialization when the first garbage collection cycle is invoked.

Although an object can start at any word in the object storage area 420, the minimum size of the object is two words including the header. Since only marked objects (live objects) can be forwarded during the compacting phase, two consecutive bits may be used for the mark bit and the forwarding bit, that is, the bit corresponding to the first word of a live object may be used as the mark bit and the bit corresponding to the second word of a live object may be used as the forwarding bit. This arrangement makes it possible to use only one bit vector for a heap block for encoding whether an object is marked as well as whether the object has been forwarded to another location. Comparing to an approach that uses two separate vectors to encode the mark bit and the forwarding bit, respectively, this arrangement can save significant memory. Using one bit vector for a heap block instead of using a centralized bit vector for all heap blocks may help parallelize marking, compacting, or sweeping process, that is, different garbage collection threads can mark, compact, or sweep different heap blocks at the same time. Such parallelism may help improve the efficiency of a mark-sweep-compact garbage collection process.

FIG. 5 shows how mark bits and forwarding bits are set for live objects 510, 520, 530, and 540 in the bit vector. One bit may be used to encode each word (4 bytes on a 32-bit machine) of allocable memory in a heap block. Because of such a correspondence between the bit vector and each word in the object storage area, a 64 k-byte heap block may only require less than 2 k bytes of bit vector space in the heap block header (typically a 64 k-byte heap block has 62 k bytes of allocable memory, which needs 62 k/4=15.5 k bits=1984 bytes). The space overhead due to the bit vector is only about 2.9%. The address of an object in a 64 k byte heap block (on a 32-bit machine) may be converted into a bit index in a bit vector as follows,
int obj_bit_index=(p_obj & 0×FFFF)>>2;
/* lower 16 bits of an object address, p_obj, are chosen and divide by 4*/.
   Similarly, a bit index in a bit vector in a 64 k byte heap block (on a 32-bit machine) may be converted into the object address as follows,
Object *p_obj=(Object *)((char *)block_address+(obj_bit_index * 4)).
   It is obvious that the spirit of this disclosure is not violated if each bit in the bit vector is used to encode more than one word of allocable memory in a heap block. For example, an application may use double words as its basic unit of memory allocation, i.e., each object can only start at an odd word in an allocable area. In this case, each bit in the bit vector may be used to encode a pair of words (double words) of allocable memory in a heap block.

Most known managed runtime systems incur an overhead of at least two words per object to store information such as type, method, hash and lock information, and the overhead is always the first two words of that object. This means that the bit after the mark bit always belongs to that object and will never be used as a mark bit because another object cannot start at that corresponding address. Therefore, the bit after the mark bit for an object may be used as the forwarding bit for the object during the compacting phase of garbage collection. Such an arrangement of only one bit vector per heap block can save storage space and improve cache performance because only one bit vector needs to be loaded into cache. In FIG. 5, both the mark bit and forwarding bit of objects 510, 520, and 530 are set, that is, these objects are live, have been marked and forwarded. For object 540, its mark bit is set, but its forwarding bit is not set, that is, object 540 is live, has been marked but has not been forwarded yet.

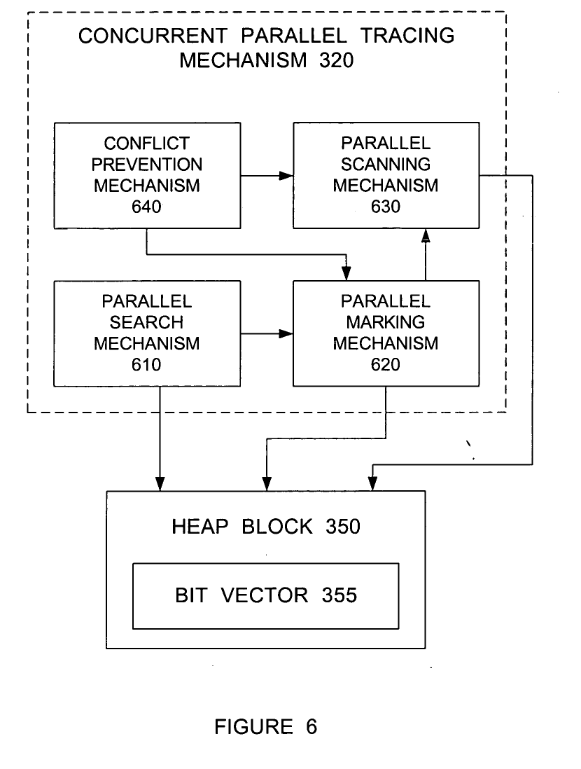

FIG. 6 is an exemplary functional block diagram of a concurrent parallel tracing mechanism that performs concurrent parallel marking functionality during mark-sweep-compact garbage collection, according to an embodiment of the present invention. The concurrent parallel tracing mechanism 320 may comprise a parallel search mechanism 610, a parallel marking mechanism 620, a parallel scanning mechanism 630, and a conflict prevention mechanism 640. The parallel search mechanism 610 may search heap blocks in a heap for live objects by traversing the reachable objects and construct a reachability graph. In one embodiment, all heap blocks in the entire heap may be searched for live objects, especially when the mark-sweep-compact garbage collection is first invoked. In another embodiment, a portion of heap blocks in the heap may be searched for live objects. For example, only those heap blocks that have not been swept may be searched for live objects since it is not necessary to search heap blocks that have recently been swept for garbage collection purposes. The parallel search mechanism running in a blocking garbage collection system may search the live objects while mutators stopped. In a non-blocking garbage collection system, however, the parallel search mechanism may search the live objects while mutators are concurrently running. In the latter situation, the reachability graph may be mutated by mutators. When this happens, freed objects may or may not be reclaimed by the garbage collector and become floating garbage. This floating garbage will usually be collected in the next garbage collection cycle because it will be garbage at the beginning of the next cycle. The inability to reclaim floating garbage immediately may be unfavorable, but may be essential to avoiding expensive coordination between mutators and the garbage collector. If mutators mutate the reachability graph during the live object searching process, space occupied by a live object may not be discovered as reachable and is thus likely to be erroneously reclaimed. Such errors may be avoided by using a tri-color tracing approach, which will be described in FIG. 7.

The parallel marking mechanism 620 may mark an object reachable from the root set. After setting the corresponding bit in the mark bit vector for this object, this object may be further scanned by the parallel scanning mechanism 630 to find any other objects that this object can reach. In a multiple thread garbage collection system, multiple threads of a garbage collector may mark and scan a heap block in parallel. The conflict prevention mechanism 640 may prevent the multiple threads from marking or scanning the same object at the same time. In other words, the conflict prevention mechanism may ensure that an object can only be successfully marked by one thread in a given garbage collection cycle, and the object is scanned exactly once thereafter usually by the very same thread. Since an object may simultaneously be seen as unmarked by two or more garbage collection threads, these threads could all concurrently try to mark the object. Measures may be taken to ensure that only one thread can succeed. In one embodiment, a byte level “lock cmpxchg” instruction, which swaps in a new byte if a previous value matches, may be used to prevent more than one thread from succeeding in marking an object. All threads may fail in marking the object, but these threads can retry until only one thread succeeds.

FIG. 7 is an exemplary flow diagram of a process of concurrent marking in using a tri-color approach, according to one embodiment of the present invention. This flow diagram can also explain how the components in a concurrent parallel tracing mechanism 320 as shown in FIG. 6 work together using a tri-color tracing approach. Under the tri-color tracing approach, white indicates an object that has not been reached or scanned, that is, an object subject to garbage collection; gray indicates an object that is reachable but has not been scanned, that is, an object that has been marked by the live object marking mechanism 620, but has not been scanned by the live object scanning mechanism 630; and black indicates an object that is reachable and has been scanned, that is, an object that has been marked by the live object marking mechanism and has been scanned by the live object scanning mechanism.

Before the tracing process starts, all objects may be initialized as white at block 710 in FIG. 7. At block 720, objects directly reachable from the root set may be examined and changed from white to gray. At block 730, each gray object may be scanned to discover its direct descendant white objects (these white objects are directly traceable from a gray object); once a gray object is scanned, the gray object may be blackened; the direct descendant white objects of the just blackened object may be colored gray. At block 740, each white object pointed to by any pointers in the root set may be changed to gray. The processing in this block may be necessary for mark-sweep-compact garbage collection since concurrently running mutators may add new references to the root set while blocks 710 to 730 are performed. At block 750, a white objected pointed to by a newly installed reference in any black object may be changed to gray. Blocks 740 and 750 may help prevent the garbage collector from erroneously reclaiming space occupied by a live object because of incorrect coordination between the concurrently running mutators and the garbage collector. At block 760, the reachability graph may be checked to determine if there are any gray objects created or encountered. If there is no gray object, the live object tracing process may be ended at block 770. If there are gray objects, blocks 730 through 760 may be reiterated until there is no gray object created or encountered. As a result, all live objects are blackened and their corresponding mark bits in the bit vector are set after the live object tracing process.

The above described tri-color tracing approach may be perceived as if the traversal of the reachability graph proceeds in a wave front of gray objects, which separates the white objects from the black objects that have been passed by the wave. In effect, there are no pointers directly from black objects to white objects, and thus mutators preserve the invariant that no black object holds a pointer directly to a white object. This ensures that no space of live objects is mistakenly reclaimed. In case a mutator creates a pointer from a black object to a white object, the mutator must somehow notify the collector that its assumption has been violated to ensure that the garbage collector's reachability graph is kept up to date. The example approaches to coordinating the garbage collect and a concurrently running mutator may involve a read barrier or a write barrier. A read barrier may detect when the mutator attempts to access a pointer to a white object, and immediately colors the object gray. Since the mutator cannot read pointers to white objects, the mutator cannot install them in black objects. A write barrier may detect when a concurrently running mutator attempts to write a pointer into an object, and trap or record the write, in effect marking it gray.

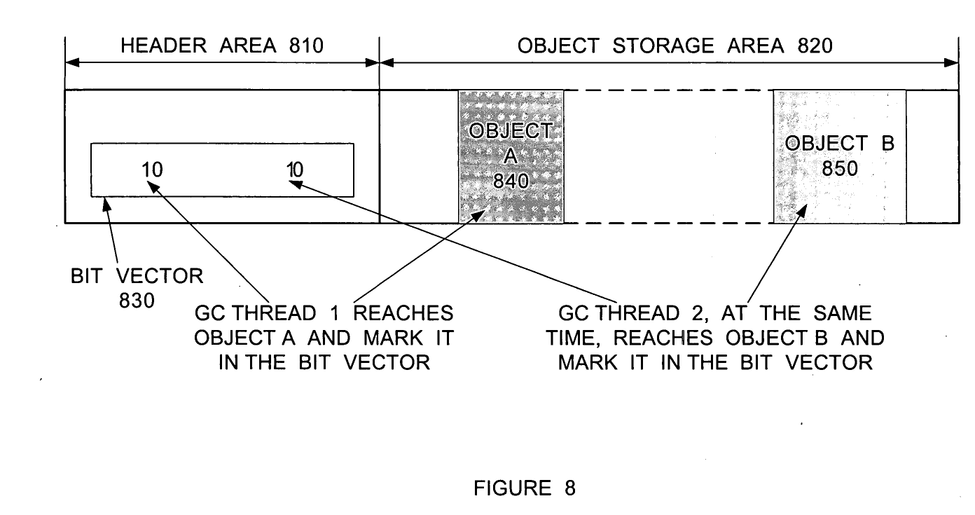

In one embodiment, a concurrent parallel tracing mechanism may work on multiple heap blocks in parallel through multiple garbage collection threads. A schematic illustration of parallel marking in a heap block is shown in FIG. 8. For example, garbage collection thread 1 may reach object A from the root set and mark it as live in the bit vector; and at the same time, garbage collection thread 2 may reach object B and mark it as live in the bit vector. In another embodiment, there may be multiple concurrent parallel tracing mechanisms working with multiple garbage collection threads on multiple heap blocks in parallel. When an object is marked and scanned, the reference slots of the object are also scanned. A reference slot stores a pointer from this object to another object, or the address of another object pointed to. If a reference slot points to an object in a heap block that will be compacted, the address of that reference slot may be recorded in a trace information storage place associated with the block that this reference slot points to. This information will be used in the subsequent compacting phase.

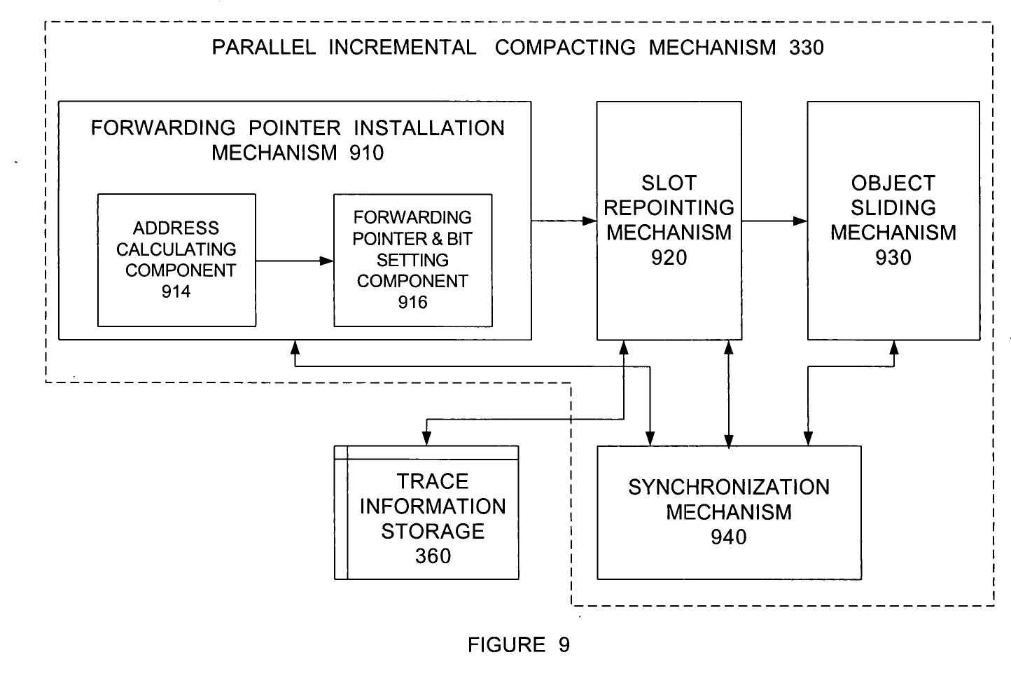

Once concurrent parallel tracing phase terminates, every live object in the heap has its mark bit set in the bit vector in the header of the heap block it is located in and the compacting phase may then start. The compacting phase is typically employed to manage memory fragmentation or to improve cache utilization. In this phase, all the live objects located in a selected heap block are slid towards the base of the heap block and tightly packed so that one large contiguous storage space at the end of the heap block may be reclaimed. Since only a fraction of heap blocks in the heap (e.g., ⅛) is chosen for compaction at each garbage collection cycle, the compacting phase is incremental. The compacted area in the heap may be referred to as the compaction region. The compacting phase is performed by a parallel incremental compacting mechanism. FIG. 9 is an exemplary functional block diagram of a parallel incremental compacting mechanism that performs parallel incremental sliding compaction during mark-sweep-compact garbage collection, according to an embodiment of the present invention.

Since the compacting phase usually comprises three sub-phases: forwarding pointer installing sub-phase, slot repainting sub-phase, and object sliding sub-phase. Accordingly, the parallel incremental compacting mechanism 330 may comprise a forwarding pointer installation mechanism 910, a slot repointing mechanism 920, and an object sliding mechanism 930. The three sub-phases may be performed in a time order (forwarding pointer installing, slot repointing, and object sliding) and the start and end of each sub-phase may define a synchronization point between multiple garbage collection threads. Synchronization may be performed by a synchronization mechanism 940. Because no data needed for three compacting sub-phases is shared across different heap blocks (all data needed for a heap block is located within that heap block), all work required during each sub-phase can thus be performed independently on different heap blocks.

The forwarding pointer installation mechanism 910 may comprise an address calculating component 914 and a forwarding pointer & bit setting component 916. When a heap block comes in, the forwarding pointer installation mechanism may examine the bit vector in its header. The forwarding pointer installation mechanism may scan the bit vector from left to right looking for set bits. Each set bit represents the base of a live object, which may be readily translated to the actual memory address of the live object. The address calculating component may then calculate where the object should be copied to when it is slid-compacted. The forwarding pointer & bit setting component may store the thus ascertained forwarding pointer (new destination address of the object) into the header of the object. In one embodiment, the forwarding pointer may be stored in the second word of the object's header. Subsequently, the forwarding bit for the object may be set in the bit vector of the heap block by the forwarding pointer & bit setting mechanism. Additionally, the address calculating component may adjust the destination address that the next live object in the heap block will go into by the size in bytes of the object just forwarded. Afterwards, the forwarding pointer installation mechanism may scan for the next set bit in the bit vector, which corresponds to the next live object in the heap block. This process continues until all live objects in the heap block have been forwarded to their corresponding destination addresses.

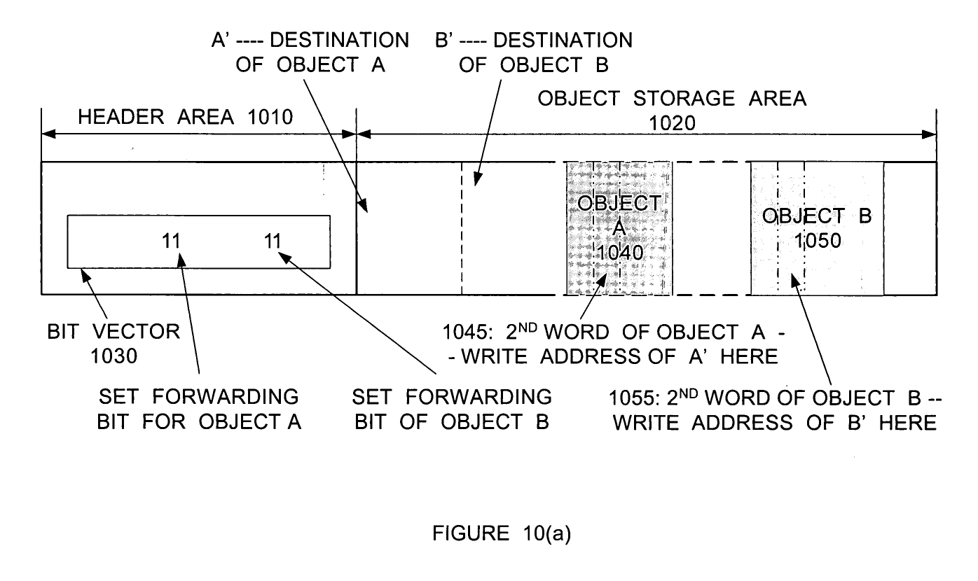

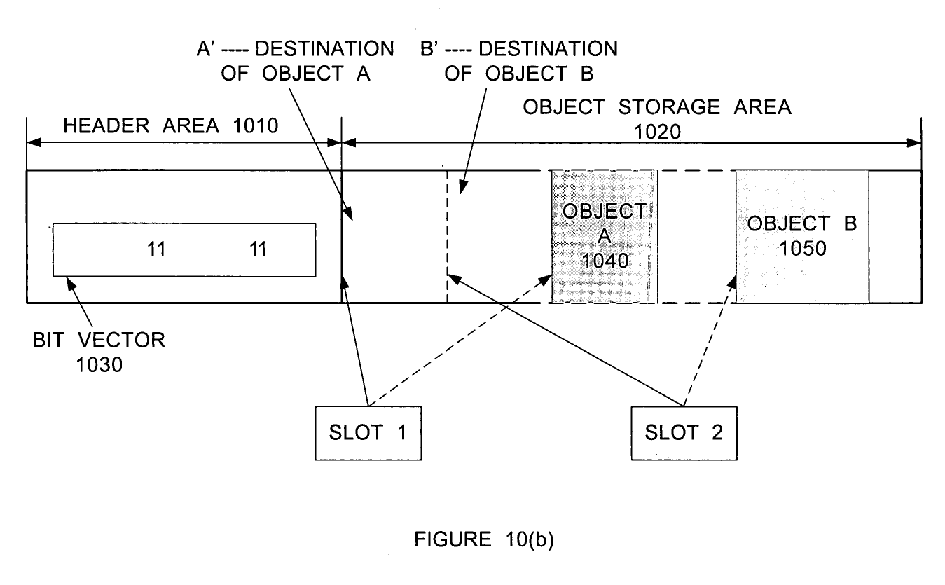

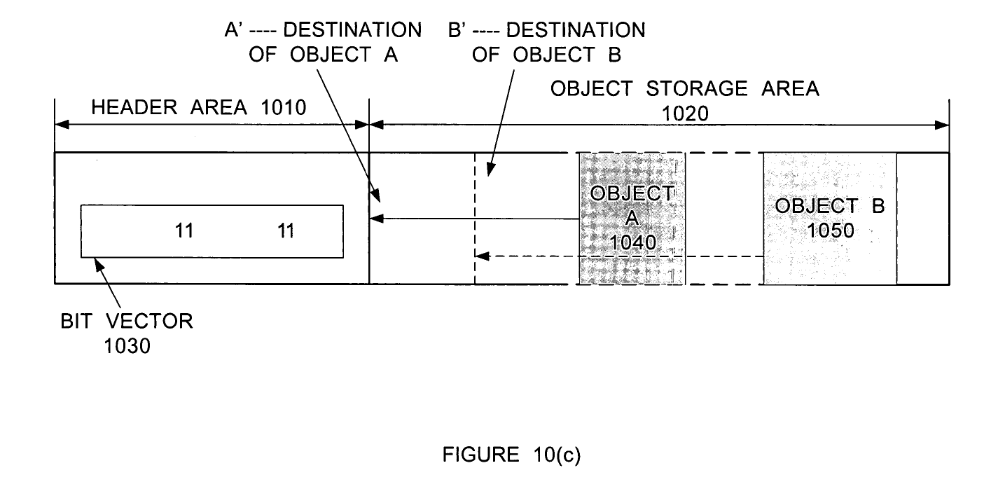

An example of the forwarding pointer installing sub-phase in the compacting phase may be illustrated by FIG. 10(a). By scanning the bit vector in the header of the heap block, live object A may be located. A new destination address for object A may be calculated and stored in the second word of its header. Subsequently the forwarding bit for object A may be set and the destination address of the next object may be adjusted by the size of object A. Afterwards, the forwarding pointer installation mechanism continues scanning the bit vector to locate the next live object, which is object B, and performs similar steps to object B as those were performed to object A. The forwarding pointer installation mechanism continues to search for the next live object until all live objects in the heap block have been forwarded. After processing this heap block, the forwarding pointer installation mechanism may perform the same above-described forwarding functionality for another heap block. For one heap block, only one single linear pass through the bit vector is needed to determine and scribble forwarding pointers for all live objects in that heap block. The forwarding pointer installing sub-phase is fully parallel since each garbage collection thread can invoke a forwarding pointer installation mechanism to work on a heap block without needing any more data than is already available in the bit vector of the heap block. In one embodiment, this parallelism may be achieved by a forwarding pointer installation mechanism that works with multiple garbage collection thread. In another embodiment, each garbage collection thread may invoke a forwarding pointer installation mechanism to achieve this parallelism.

The slot repainting mechanism 920 as shown in FIG. 9 may repoint those objects that are currently pointing to an object just forwarded to the new destination address of the object. When a heap block comes in, the slot repointing mechanism may examine all slots that point into this heap block, that is, slots of objects in other heap blocks that contain a reference pointer to an object in this heap block. This information is collected on a per-compacted heap block basis and stored in a trace information storage associated with this heap block, during the marking phase. For each such slot, the slot repainting mechanism may identify which object in the heap block the slot points to (referenced object) and may determine whether the referenced object has been forwarded by checking whether the forwarding bit of the referenced object is set in the bit vector. If the referenced object being pointed to has been forwarded, the slot repointing mechanism may read the forwarding pointer of the referenced object and then repoint that slot by writing into it the forwarding pointer address. Thus, the slot now points to the address in the heap block where the referenced object will be eventually copied into.

An example of the slot repointing sub-phase in the compacting phase may be illustrated in FIG. 10(b). There are two slots in objects outside a heap block as shown in the figure, slot 1 and slot 2, pointing to object A and object B in the heap block, respectively. For slot 1, a slot repainting mechanism may first determine if object A 1040, which slot 1 points to, has been forwarded by checking the forwarding bit in the bit vector 1030 of object A. If the forwarding bit of object A is set, this means that object A has been forwarded. Thus, the slot repointing mechanism may read the forwarding pointer of object A and repoint slot 1 by writing into slot 1 the forwarding pointer address so that slot 1 can point to the destination address A′ of object A. Similarly, slot 2 can be repointed to the destination address B′ of object B. Once repointing all slots that point into this heap block is complete, the slot repointing mechanism may move onto another heap block to perform the same above-described slot repainting functionality. In one embodiment, a slot repointing mechanism may work with multiple garbage collection threads so that it can perform slot repointing for multiple heap blocks in parallel. In another embodiment, each multiple garbage collection thread may invoke a slot repainting mechanism to repoint slots that point to a heap block. Slot repointing for a heap block is independent from slot repainting for another heap block because no more data is need than what is already available in the forwarding bits/addresses in the heap block and the set of slots referenced by this block may need to be changed.

The object sliding mechanism 930 as shown in FIG. 9 may slide (copy) an object, which has been forwarded, to the object's destination address in the same heap block or another heap block. When a heap block comes in, the object sliding mechanism may scan the bit vector of the heap block from left to right looking for set bits. Since both mark bit and forwarding bit of each live object in a heap block, which is selected for compaction, have been set after the forward pointer installing sub-phase of the compacting phase, it is only necessary to search for mark bits in the bit vector. Once a set bit (mark bit) is found, the set bit is quickly translated into a memory address (source address) of an object corresponding to the set bit. The forwarding pointer in the header of the object may be read, which is the destination address of the object. The bytes spanned by the object are copied from its source address to its destination address. The object sliding mechanism may then move on to the next set bit (mark bit) and perform a similar slide until all live objects in the heap block have been slid. The object sliding mechanism may then mark the heap block as swept and denote the contiguous space in the heap block beyond the last byte of the last live object in that heap block as a free allocation area. For one heap block, only one single linear pass through the bit vector is needed to slide all live objects in that heap block.

An example of the object sliding sub-phase in the compacting phase may be illustrated in FIG. 10(c). As shown in the figure, live object A may be first found by scanning the bit vector 1030 from left to right. The source address of object A may be translated from its mark bit index in the bit vector. The destination address of object A may be read from its header (forwarding pointer). Object A may then be copied from its source address to its destination address. Subsequently, the object sliding mechanism may find object B by continuing to scan the bit vector and perform a slide for object B. After all live objects in the heap block have been slid, a contiguous space to the right of the last byte of the last live object may be made allocable by running mutators. The object sliding sub-phase may be full parallel because all the information needed to slide live objects in a heap block is present in the headers of live objects in the heap block and in the bit vector of the heap block. In one embodiment, this parallelism may be achieved by an object sliding mechanism working with multiple garbage collection threads. In another embodiment, each garbage collection thread may invoke an object sliding mechanism to work on a heap block to achieve this parallelism.

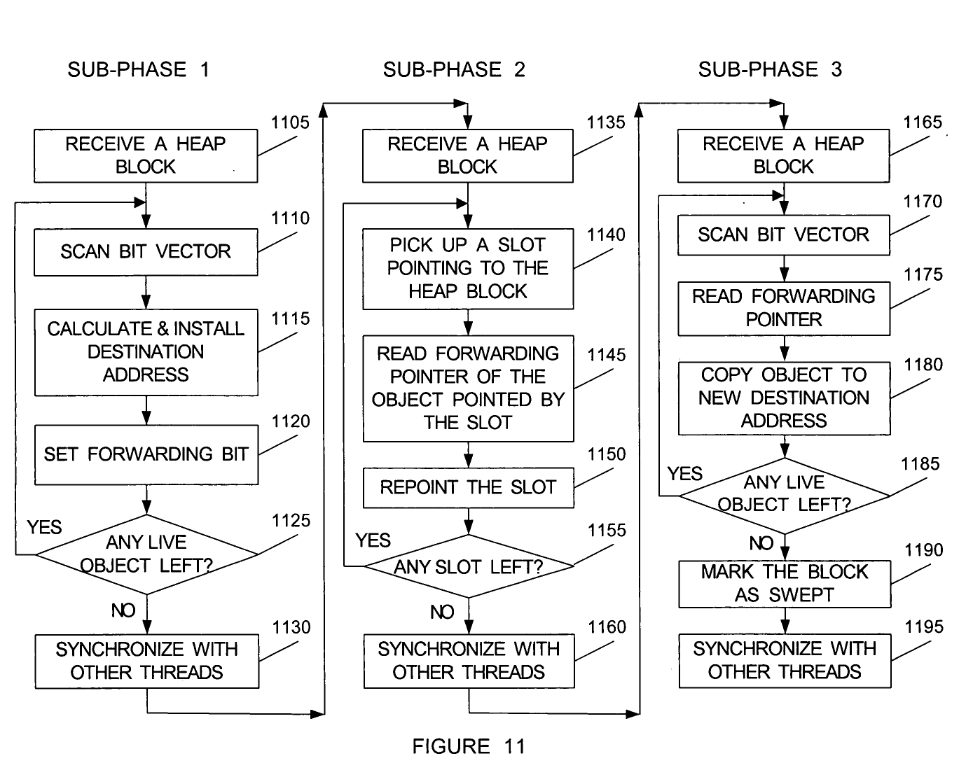

FIG. 11 is an exemplary flow diagram of a process in which parallel incremental sliding compaction is performed during mark-sweep-compact garbage collection, according to an embodiment of the present invention. The blocks in the process shown in the figure performs the compacting phase, which in turn comprises three sub-phases: forwarding pointer installing sub-phase (sub-phase 1), slot repainting sub-phase (sub-phase 2), and object sliding sub-phase (sub-phase 3). Blocks 1105 through 1130 may be performed during sub-phase 1. At block 1105, a heap block selected for compaction may be received. At block 1110, the bit vector of the heap block may be scanned from left to right to find set bits so that live objects in the heap block may be located one by one, based on the relationship between the bit index in the bit vector and object address in the heap block. At block 1115, the destination address of a live object may be calculated and installed in the header of the live object. At block 1120, the forwarding bit of the live object in the bit vector may be set. At block 1125, the bit vector of the heap block may be checked to determine whether there is any set bits left (i.e., any live objects left). If there is any live objects left, blocks 1110 through 1125 may be reiterated until all live objects in the heap block have been forwarded. At block 1130, synchronization may be performed among all heap blocks selected for compaction so that these heap blocks have all completed sub-phase 1 processing before sub-phase 2 can start.

During sub-phase 2, blocks 1135 through 1160 may be performed. At block 1135, a heap block for which sub-phase 1 has been performed may be received. At block 1140, a slot among all slots that point into this heap block may be picked up. At block 1145, the forwarding pointer of the object that the slot points to may be read from the object's header. At block 1150, the slot may be repainted to the object's destination address by writing into the slot the forwarding pointer address. At block 1155, a decision whether all slots that point into this heap block have been repointed may be made. If there is any such slots left, blocks 1140 through 1155 may be reiterated until all such slots have been repainted. At block 1160, synchronization may be performed among all heap blocks selected for compaction so that these heap blocks have all completed sub-phase 2 processing before sub-phase 2 can start.

During sub-phase 3, blocks 1165 through 1195 may be performed. At block 1165, a heap block for which both sub-phase 1 and sub-phase 2 have been performed may be received. At block 1170, the bit vector of the heap block may be scanned from left to right to find set bits so that live objects in the heap block may be located one by one, based on the relationship between the bit index in the bit vector and object address in the heap block. At block 1175, the forwarding pointer (and thus destination address) of a live object may be read from the object's header. At block 1180, the live object may be copied to from its current address to its destination address in the same heap block or another heap block. At block 1185, the bit vector of the heap block may be checked to determine whether there is any set bits left (i.e., any live objects left). If there is any live objects left, blocks 1170 through 1185 may be reiterated until all live objects in the heap block have been copied to their destination addresses. At block 1190, the heap block may be marked as swept. At block 1130, synchronization may be performed among all heap blocks selected for compaction so that these heap blocks have all completed sub-phase 3 processing before the sweeping phase can start.

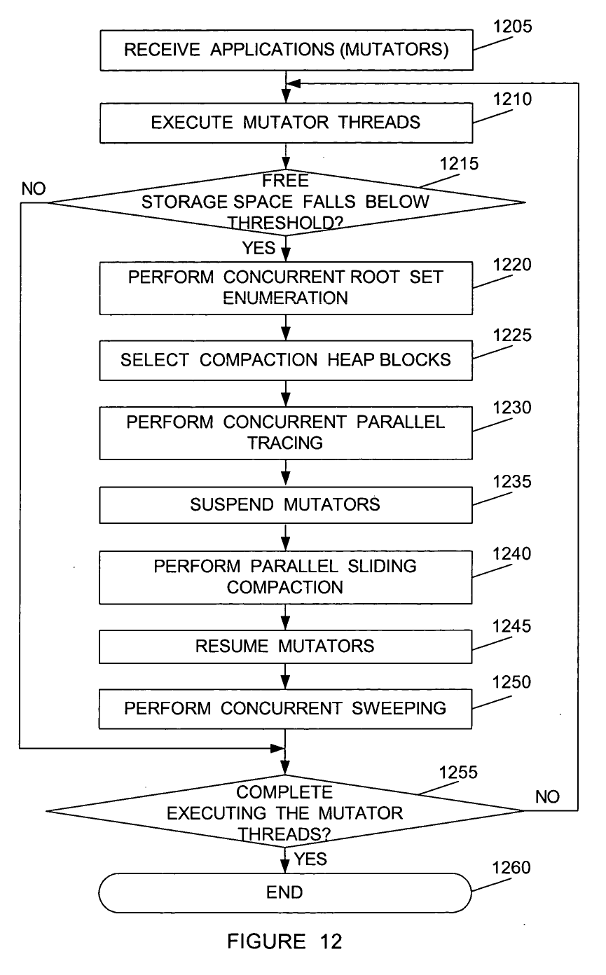

FIG. 12 is an exemplary flow diagram of a high-level process in which the concurrency and parallelism of mark-sweep-compact garbage collection is improved, according to an embodiment of the present invention. At block 1205, one or more applications (mutators) may be received by a managed runtime system. At block 1210, mutators may be set to run in at least one thread. While mutator threads are executing, the free storage space in the heap of the managed runtime system may be monitored at block 1215. If the free storage space in the heap falls below a threshold, a garbage collector may be invoked to perform mark-sweep-compact garbage collection. At block 1220, root set enumeration may be performed concurrently with mutator threads to obtain a root set (a set of direct references to objects used by the currently executing mutator threads). At block 1225, heap blocks that will be compacted may be selected. At block 1230, multiple heap blocks in the heap may be traced in parallel and concurrently with the executing mutator threads to find all live objects, which are reachable from the root set. All lived objects located may be marked by setting their corresponding bits in the bit vector of a heap block. Also at this block, if a slot points into a heap block that will be compacted, the address of this slot may be recorded in a trace information storage place associated with the heap block that this slots points into. When live objects in all heap blocks are traced, the compacting phase may start. Because the compacting phase involves moving live objects and repointing slots to new addresses of the moved live objects, all running mutator threads may need to be suspended at block 1235 to avoid execution errors. At block 1240, heap blocks selected for compaction may be compacted in parallel to make a contiguous free space in each heap block available for allocation, through three sub-phases (forwarding pointer installing sub-phase, slot repainting sub-phase, and object sliding sub-phase) as described in the above. After all selected heap blocks have been compacted, all mutator threads may be resumed at block 1245. At block 1250, sweeping process may be performed concurrently with other executing mutator threads if a mutator thread runs out of space. At block 1255, a decision whether all mutator threads have completed their execution may be made. If there are still some mutator threads running, process in blocks 1215 through 1255 may be reiterated until all mutator threads have completed their execution.

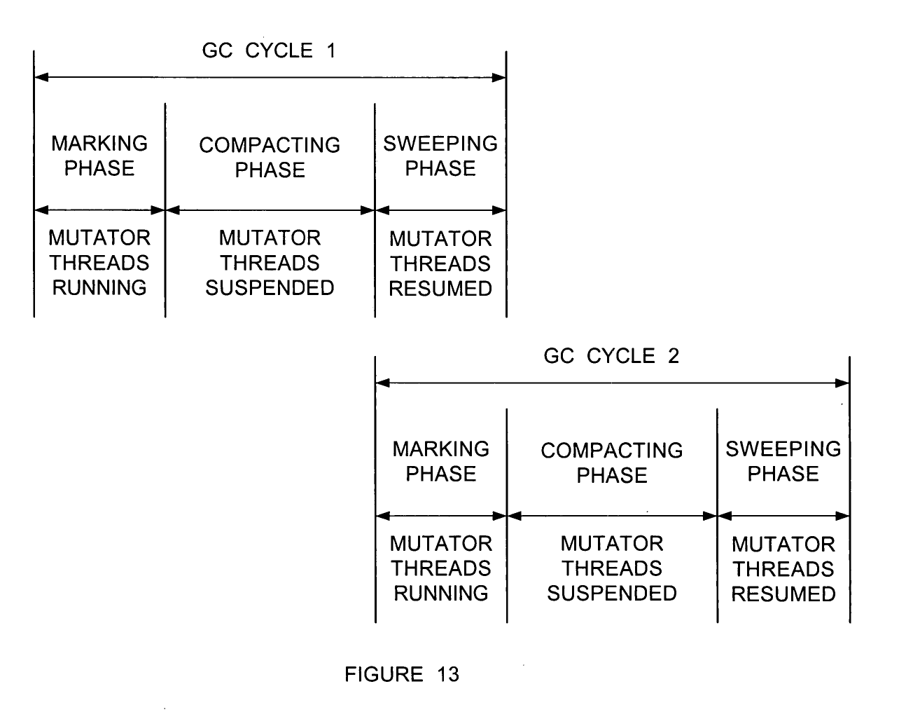

FIG. 13 is a schematic illustration of how concurrency is achieved among garbage collection threads and between garbage collection threads and mutator threads during mark-sweep-compact garbage collection, according to an embodiment of the present invention. With each garbage collection thread, the marking phase and the sweeping phase may proceed concurrently with executing mutator threads. However, mutator threads need be suspended during the compacting phase to avoid any execution errors because some live objects are moving in this phase. In each of marking, compacting, and sweeping phase, multiple garbage collection threads may proceed in parallel for multiple heap blocks. As shown in FIG. 13, the sweeping phase in a garbage collection cycle may proceed concurrently with the marking phase of the next garbage collection cycle by using two separate bit vectors for each heap block, one for marking and the other for sweeping and toggling these two bit vectors at the end of the compacting phase. This may help improve the concurrency of a mark-sweep-compact garbage collector.

Although the present invention is concerned with using one bit vector for a heap block to improve the concurrency and parallelism of mark-sweep-compact garbage collection, persons of ordinary skill in the art will readily appreciate that the present invention may be used for improving the concurrency and parallelism by other types of garbage collection. Additionally, the present invention may be used for automatic garbage collection in any systems such as, for example, managed runtime environments running Java, C#, and/or any other programming languages.

Although an example embodiment of the present invention is described with reference to block and flow diagrams in FIGS. 1-13, persons of ordinary skill in the art will readily appreciate that many other methods of implementing the present invention may alternatively be used. For example, the order of execution of the functional blocks or process steps may be changed, and/or some of the functional blocks or process steps described may be changed, eliminated, or combined.

In the preceding description, various aspects of the present invention have been described. For purposes of explanation, specific numbers, systems and configurations were set forth in order to provide a thorough understanding of the present invention. However, it is apparent to one skilled in the art having the benefit of this disclosure that the present invention may be practiced without the specific details. In other instances, well-known features, components, or modules were omitted, simplified, combined, or split in order not to obscure the present invention.

Embodiments of the present invention may be implemented on any computing platform, which comprises hardware and operating systems. The hardware may comprise a processor, a memory, a bus, and an I/O hub to peripherals. The processor may run a compiler to compile any software to the processor-specific instructions. Processing required by the embodiments may be performed by a general-purpose computer alone or in connection with a special purpose computer. Such processing may be performed by a single platform or by a distributed processing platform. In addition, such processing and functionality can be implemented in the form of special purpose hardware or in the form of software.

If embodiments of the present invention are implemented in software, the software may be stored on a storage media or device (e.g., hard disk drive, floppy disk drive, read only memory (ROM), CD-ROM device, flash memory device, digital versatile disk (DVD), or other storage device) readable by a general or special purpose programmable processing system, for configuring and operating the processing system when the storage media or device is read by the processing system to perform the procedures described herein. Embodiments of the invention may also be considered to be implemented as a machine-readable storage medium, configured for use with a processing system, where the storage medium so configured causes the processing system to operate in a specific and predefined manner to perform the functions described herein.

While this invention has been described with reference to illustrative embodiments, this description is not intended to be construed in a limiting sense. Various modifications of the illustrative embodiments, as well as other embodiments of the invention, which are apparent to persons skilled in the art to which the invention pertains are deemed to lie within the spirit and scope of the invention.

1. A method for performing mark-sweep-compact garbage collection, comprising:
receiving an application;
executing the application in at least one thread;
determining if available space in a heap falls below a threshold;
performing mark-sweep-compact garbage collection in the heap using a bit vector for each heap block for marking, sweeping, and compacting, if the available space falls below the threshold; and otherwise,
continuing executing the application and monitoring if the available space in the heap falls below the threshold;
wherein the heap comprises at least one heap block and a heap block comprises only one bit vector.

2. The method of claim 1, wherein the bit vector of a heap block has a number of bits, wherein the number of bits is the same as the number of words in object storage space of the heap block with each bit corresponding to a word, and no two or more bits corresponding to the same word in the object storage space.

3. The method of claim 1, further comprising initializing elements of the bit vector in each heap block to zeros.

4. The method of claim 1, wherein performing mark-sweep-compact garbage collection comprises:
selecting a number of heap blocks for compaction;
invoking at least one garbage collection thread to trace live objects in all heap blocks of the heap, concurrently while executing the application;
performing parallel incremental sliding compaction on the selected heap blocks; and
sweeping a heap block that is not selected for compaction to make storage space occupied by objects other than live objects in the heap block allocable.

5. The method of claim 4, wherein tracing the live objects in all heap blocks comprises parallel marking the live objects by at least one garbage collection thread.

6. The method of claim 5, wherein parallel marking the live objects comprises setting mark bits of the live objects in the one bit vector to 1, by the at least one garbage collection thread; but disallowing more than one garbage thread to mark a same live object simultaneously.

7. The method of claim 6, wherein a mark bit of a live object in a bit vector of a heap block comprises a bit corresponding to the first word of storage space occupied by the live object.

8. The method of claim 4, wherein performing parallel incremental sliding compaction on the selected heap blocks comprises installing forwarding pointers, repainting slots, and sliding live objects for the selected heap blocks; wherein installing, repainting, and sliding each comprises a parallel process performed by at least one garbage collection thread with one garbage collection thread working on one of the selected heap blocks.

9. The method of claim 8, wherein installing forwarding pointers comprises:
identifying a live object based on information in a bit vector of a heap block;
calculating and installing a forwarding pointer in the live object;
setting a forwarding bit in the bit vector to 1, the forwarding bit corresponding to the live object in the heap block; and
repeating identifying, calculating, and setting for each live object in the heap block;
wherein the heap block is one of the selected heap blocks.

10. The method of claim 9, wherein the forwarding bit of a live object comprises a bit in the bit vector corresponding to the second word of storage space occupied by the live object.

11. The method of claim 8, wherein repainting slots comprises:
selecting a slot that points to a live object in a heap block;
reading a forwarding pointer of the live object based on information in a bit vector of the heap block;
repainting the slot to the forwarding pointer; and
repeating selecting, reading, and repointing for each slot that points to a live object in the heap block;
wherein the heap block is one of the selected heap blocks.

12. The method of claim 8, wherein sliding live objects comprises:
identifying a live object based on information in a bit vector of a heap block;
reading a forwarding pointer of the live object;
copying the live object to an address indicated by the forwarding pointer;
repeating identifying, reading, and copying for each live object in the heap block; and
making a storage space not occupied by newly copied live objects available for allocation;
wherein the heap block is one of the selected heap blocks.

13. The method of claim 4, wherein sweeping a heap block is performed using information in a bit vector of the heap block, concurrently while the application is running.

14. The method of claim 13, further comprising setting all bits in the bit vector to 0 after completing sweeping the heap block.

15. The method of claim 1, further comprising performing another cycle of mark-sweep-compact garbage collection when available space in the heap falls below the threshold again.

16. The method of claim 8, wherein installing forwarding pointers is completed for the selected heap blocks before repointing slots is started and repainting slots is completed for the selected heap blocks before sliding objects is started.

17. A method for automatically collecting garbage objects, comprising:
receiving a first code;
compiling the first code into a second code;
executing the second code in at least one thread; and
automatically performing mark-sweep-compact garbage collection to ensure there is enough storage space available for executing the second code, using only one bit vector for a heap block for marking, forwarding, and sweeping.

18. The method of claim 17, wherein automatically performing mark-sweep-compact garbage collection comprises detecting if available space in a heap falls below a threshold and invoking the mark-sweep-compact garbage collection if the available space does fall below the threshold.

19. The method of claim 18, wherein the heap comprises at least one heap block, a heap block having only one bit vector.

20. The method of claim 17, wherein the only one bit vector of the heap block comprises a number of bits, wherein the number of bits is the same as the number of words in object storage space of the heap block with each bit corresponding to a word and no two or more bits corresponding to the same word in the object storage space.

21. The method of claim 20, wherein a bit corresponding to the first word of storage space occupied by an object is a mark bit for the object, and a bit corresponding to the second word of storage space occupied by the object is a forwarding bit of the storage space.

22. The method of claim 21, wherein the mark bit and the forwarding bit encode information used for marking, compacting, and sweeping.

23. The method of claim 17, wherein marking, compacting, and sweeping, each proceeds in parallel; and marking and sweeping, each proceeds concurrently while the second code is executed.

24. A system for mark-sweep-compact garbage collection, comprising:
a root set enumeration mechanism to enumerate direct references to live objects in a heap, wherein the heap comprises at least one heap block;
a concurrent parallel tracing mechanism to parallel trace a live object and mark the live object in a bit vector of a heap block where the live object is located, concurrently with execution of an application;
a parallel incremental compacting mechanism to slide live objects in a heap block to a first area of the heap block to leave a contiguous allocable space at a second area of the heap block, using a bit vector of the heap block; and
a concurrent garbage sweeping mechanism to make storage space occupied by garbage objects in a heap block allocable using a bit vector of the heap block, concurrently with the execution of the application;
wherein a heap block has only one bit vector for tracing, compacting, and sweeping.

25. The system of claim 24, wherein the only one bit vector of a heap block comprises a mark bit indicating whether an object in the heap block has been marked and a forwarding bit indicating whether the object has been forwarded.

26. The system of claim 24, wherein the concurrent parallel tracing mechanism comprises:
a parallel search mechanism to parallel search live objects in a heap block by at least one garbage collection thread;
a parallel marking mechanism to parallel mark the live objects in a bit vector of the heap block by the at least one garbage collection thread;
a parallel scanning mechanism to parallel scan any objects reachable from the live objects; and
a conflict prevention mechanism to prevent more than one garbage collection thread from marking the same object at the same time;

27. The system of claim 24, wherein the parallel incremental compacting mechanism comprises:
a forwarding pointer installation mechanism to install a destination address in a live object in a heap block and to set a forwarding bit in the bit vector of the heap block to 1;
a slot repointing mechanism to repoint slots that point to the live object to the destination address of the live object; and
an object sliding mechanism to slide the live object to the destination address.

28. The system of claim 27, wherein the forwarding pointer installation mechanism comprises:
an address calculating component to calculate a destination address of a live object in a heap block; and
a forwarding pointer & bit setting mechanism to install the destination address in the live object and to set a forwarding bit of the live object to 1 in a bit vector of the heap block.

29. A managed runtime system, comprising:
a just-in-time compiler to compile an application into a code native to underlying computing platform;
a virtual machine to execute the application; and
a garbage collector
to parallel trace a live object in a heap and mark the live object in a bit vector of a heap block where the live object is located, concurrently with execution of the software application, and
to perform parallel incremental sliding compaction using a bit vector for a heap block;
wherein the heap comprises at least one heap blocks and a heap block has only one bit victor which comprises a mark bit indicating whether an object in the heap block has been marked and a forwarding bit indicating whether the object has been forwarded for parallel incremental sliding compaction.

30. The system of claim 29, further comprising a concurrent garbage sweeping mechanism to sweep storage space occupied by garbage objects in a heap block to make the storage space allocable using information encoded in mark bits in a bit vector of the heap block, concurrently with the execution of the software application.

31. The system of claim 29, wherein the garbage collector comprises:
a concurrent parallel tracing mechanism to parallel trace a live object and mark the live object by setting a mark bit of the live object to 1 in a bit vector of the heap block, concurrently with execution of the application; and
a parallel incremental compacting mechanism
to install a destination address in a live object in a heap block and to set a forwarding bit in the bit vector of the heap block to 1;
to repoint slots that point to the live object to the destination address of the live object; and
to slide the live object to the destination address.

32. An article comprising: a machine accessible medium having content stored thereon, wherein when the content is accessed by a processor, the content provides for performing mark-sweep-compact garbage collection, including:
receiving an application;
executing the application in at least one thread;
determining if available space in a heap falls below a threshold;
performing mark-sweep-compact garbage collection in the heap using a bit vector for each heap block for marking, sweeping, and compacting, if the available space falls below the threshold; and otherwise,
continuing executing the application and monitoring if the available space in the heap falls below the threshold;
wherein the heap comprises at least one heap block and a heap block comprises only one bit vector.

33. The article of claim 32, wherein the bit vector of a heap block has a number of bits, wherein the number of bits is the same as the number of words in object storage space of the heap block with each bit corresponding to a word, and no two or more bits corresponding to the same word in the object storage space.

34. The article of claim 32, further comprising content for initializing elements of the bit vector in each heap block to zeros.

35. The article of claim 32, wherein the content for performing mark-sweep-compact garbage collection comprises content for:
selecting a number of heap blocks for compaction;
invoking at least one garbage collection thread to trace live objects in all heap blocks of the heap, concurrently while executing the application;
performing parallel incremental sliding compaction on the selected heap blocks; and
sweeping a heap block that is not selected for compaction to make storage space occupied by objects other than live objects in the heap block allocable.

36. The article of claim 35, wherein the content for tracing the live objects in all heap blocks comprises content for parallel marking the live objects by at least one garbage collection thread.

37. The article of claim 36, wherein the content for parallel marking the live objects comprises content for setting mark bits of the live objects in the one bit vector to 1, by the at least one garbage collection thread; but disallowing more than one garbage thread to mark a same live object simultaneously.

38. The article of claim 37, wherein a mark bit of a live object in a bit vector of a heap block comprises a bit corresponding to the first word of storage space occupied by the live object.

39. The article of claim 35, wherein the content for performing parallel incremental sliding compaction on the selected heap blocks comprises content for installing forwarding pointers, repainting slots, and sliding live objects for the selected heap blocks; wherein installing, repointing, and sliding each comprises a parallel process performed by at least one garbage collection thread with one garbage collection thread working on one of the selected heap blocks.

40. The article of claim 39, wherein content for installing forwarding pointers comprises content for:
identifying a live object based on information in a bit vector of a heap block;
calculating and installing a forwarding pointer in the live object;
setting a forwarding bit in the bit vector to 1, the forwarding bit corresponding to the live object in the heap block; and
repeating identifying, calculating, and setting for each live object in the heap block;
wherein the heap block is one of the selected heap blocks.

41. The article of claim 40, wherein the forwarding bit of a live object comprises a bit in the bit vector corresponding to the second word of storage space occupied by the live object.

42. The article of claim 39, wherein the content for repointing slots comprises content for:
selecting a slot that points to a live object in a heap block;
reading a forwarding pointer of the live object based on information in a bit vector of the heap block;
repainting the slot to the forwarding pointer; and
repeating selecting, reading, and repainting for each slot that points to a live object in the heap block;
wherein the heap block is one of the selected heap blocks.

43. The article of claim 39, wherein the content for sliding live objects comprises content for:
identifying a live object based on information in a bit vector of a heap block;
reading a forwarding pointer of the live object;
copying the live object to an address indicated by the forwarding pointer;
repeating identifying, reading, and copying for each live object in the heap block; and
making a storage space not occupied by newly copied live objects available for allocation;
wherein the heap block is one of the selected heap blocks.

44. The article of claim 35, wherein sweeping a heap block is performed using information in a bit vector of the heap block, concurrently while the application is running.

45. The article of claim 44, further comprising setting all bits in the bit vector to 0 after completing sweeping the heap block.

46. The article of claim 32, further comprising content for performing another cycle of mark-sweep-compact garbage collection when available space in the heap falls below the threshold again.

47. The article of claim 39, wherein installing forwarding pointers is completed for the selected heap blocks before repainting slots is started and repainting slots is completed for the selected heap blocks before sliding objects is started.

48. An article comprising: a machine accessible medium having content stored thereon, wherein when the content is accessed by a processor, the content provides for automatically collecting garbage objects, including:
receiving a first code;
compiling the first code into a second code;
executing the second code in at least one thread; and
automatically performing mark-sweep-compact garbage collection to ensure there is enough storage space available for executing the second code, using only one bit vector for a heap block for marking, forwarding, and sweeping.

49. The article of claim 48, wherein the content for automatically performing mark-sweep-compact garbage collection comprises content for detecting if available space in a heap falls below a threshold and invoking the mark-sweep-compact garbage collection if the available space does fall below the threshold.

50. The article of claim 49, wherein the heap comprises at least one heap block, a heap block having only one bit vector.

51. The article of claim 48, wherein the only one bit vector of the heap block comprises a number of bits, wherein the number of bits is the same as the number of words in object storage space of the heap block with each bit corresponding to a word and no two or more bits corresponding to the same word in the object storage space.

52. The article of claim 51, wherein a bit corresponding to the first word of storage space occupied by an object is a mark bit for the object, and a bit corresponding to the second word of storage space occupied by the object is a forwarding bit of the storage space.

53. The article of claim 52, wherein the mark bit and the forwarding bit encode information used for marking, compacting, and sweeping.

54. The article of claim 48, wherein marking, compacting, and sweeping, each proceeds in parallel; and marking and sweeping, each proceeds concurrently while the second code is executed.
